(19) United States
(12) Patent Application Publication
(10) Pub. No.: US 2005/0271917 A1
(43) Pub. Date: Dec. 8, 2005

(54) Electrochemical reactor for aircraft and method for operating the electrochemical reactor

(75) Inventors: Claus Hoffjann, Neu Wulmstorf (DE); Hans-Georg Schuldzig, Jork (DE); Harald Gruendel, Hamburg (DE); Hans-Juergen Heinrich, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 11/135,168

(22) Filed: May 23, 2005

Related U.S. Application Data
(60) Provisional application No. 60/598,243, filed on Aug. 3, 2004.

(30) Foreign Application Priority Data
May 28, 2004 (DE) 10 2004 026 227.6

(51) Int. Cl. H01M 8/18; H01M 8/06; H01M 8/04

(52) U.S. Cl. 429/21; 429/22; 429/17

(57) ABSTRACT

In present-day aircraft, common containers for storing of the raw materials required for on-board operation, such as oxygen and water, are used. Energy is produced by using generators and turbines. According to one exemplary embodiment of the present invention, an electrochemical reactor for producing energy, hydrogen, oxygen, and clear water is provided, which ensures the on-board supply. According to the invention, hereby released reaction heat is used as additional process heat in an SOSE- and FP-process. In addition, by use of the hydrogen produced in the process, an extra desulphurization unit is eliminated with the fuel processing of the fuel in the FP process. In this manner, large storage volumes and weight can be saved.

### CROSS-REFERENCE TO RELATED APPLICATIONS

This application claims the benefit of the filing date of U.S. Provisional Patent Application No. 60/598,243 filed Aug. 3, 2004, the disclosure of which is hereby incorporated herein by reference.

### BACKGROUND OF THE INVENTION

The present invention relates to a supply system in aircraft. In particular, the present invention relates to an electrochemical reactor for producing energy, hydrogen, oxygen, and clear water from grey water, a hydrocarbon-containing fuel and air in an aircraft or spacecraft, an aircraft with an electrochemical reactor, as well as a method for operating a corresponding electrochemical reactor.

In aircraft, supply systems are used for supplying the inner on-board region with oxygen and clear water and for supplying corresponding electrical consumers with electrical energy. Typically, the required raw materials, such as oxygen and clear or drinking water are stored in corresponding containers, which are loaded before beginning the flight. In this connection, the high weight of the supply containers as well as the partially enormous space requirements are disadvantageous, which are occupied by the large storage volumes.

According to an exemplary embodiment of the present invention, an electrochemical reactor for producing energy, hydrogen, oxygen, and clear water from grey water, a hydrocarbon-containing fuel and air in an aircraft or spacecraft is provided. The electrochemical reactor hereby includes a fuel cell assembly, subsequently referred to as an SOSE assembly, and a fuel cell processor assembly, subsequently referred to as an FP assembly.

This may allow for an improved provisioning of aircraft with energy and raw materials.

Advantageously, an electrochemical reactor may be provided, which represents an autonomous system for on-board supply, so that large storage volumes and weight for storing required raw materials or also for producing energy can be reduced or even avoided.

According to a further embodiment of the present invention, the process heat produced by the SOFC assembly is useable in the SOSE assembly for an electrolytic process and in the FP assembly for a reforming process. In addition, the proposed electrochemical reactor is designed, such that the hydrogen produced in the SOSE assembly can be used for a cyclical regeneration of individual SOFC anodes, so that advantageously, a separate desulphurization assembly is eliminated and any thermal load alternations can be driven without degradation losses.

According to a further embodiment of the present invention, the electrochemical reactor includes further a control unit for controlling or regulating the processes running in the reactor, such that the energy produced by the SOFC assembly corresponds to the energy required by the SOSE assembly or by the FP assembly or by the on-board operation, whereby the load range, in which the processes are driven, is continuous, and whereby the processes yield altogether at least a part of the electrical energy, the oxygen, and the clear water required for the on-board operation.

Advantageously, this is believed to make it possible, for example, that the thermal cycling of both high temperature systems SOSE and SOFT is stabilized, so that an extensive correction is eliminated. In addition, a corresponding regulation of the three assemblies (SOFC, SOSE, FP) makes possible that at each time point, the energy, oxygen, and clear water required for on-board operation maybe made available, and at the same time, no excess is produced or a possible loss is held to a minimal level.

According to a further embodiment of the present invention, the SOFC assembly, the SOSE assembly, and the FP assembly are arranged in a thermally insulated casing.

A heat loss to the environment may hereby be effectively avoided, so that a maximal utilization of the energy produced by the entire system is possible.

According to a further embodiment of the present invention, the SOSE assembly or the SOFC assembly is formed at least partially from oxygen ion-conducting solid electrolytes.

In this manner, additional stability of both assemblies maybe achieved. In addition, the use of solid electrolytes in the cells leads to a simplified manufacture and later manipulation of the cells.

According to a further exemplary embodiment of the present invention, the SOSE assembly includes a first SOSE cell or a second SOSE cell. In addition, the SOFC assembly includes a first SOFC cell or a second SOFC cell and the FP assembly includes a first FP cell or a second FP cell. At least two of these cells are connected in parallel or in series to one another.

Because of these parallel or serial connections or parallel-serial connections of different cells, an increased flexibility in design of the electrochemical reactor maybe achieved, whereby different configurations, adapted to the desired system specifications, are made possible. In addition, a modular-type connection of different cells or cell assemblies facilitates later maintenance or exchange of defective individual cells.

According to a further advantageous embodiment of the present invention, the first SOSE cell is formed with at least a third SOSE cell as a multi-cellular electrolytic cell stack or the first SOFC cell is formed with at least a third SOFC cell as a multi-cellular fuel cell stack.

This may lead to an increased flexibility with the assembly of the entire system, since the corresponding stacks already can be configured accordingly at the factory.

According to a further exemplary embodiment of the present invention, the oxygen produced in the SOSE assembly can be supplied to a cathode of the SOFC assembly, to application in the on-board operation, to a PEM-fuel cell (polymer-electrolytic-fuel cell), or a downstream combustion process.

By means of a corresponding redistribution of the produced oxygen by the control unit, advantageously, the supply of the corresponding module (SOFC assembly, PEM fuel cell, downstream combustion module, or also, however, an on-board operating module) may be ensured, so that a substantial self-sustaining operation of the electrochemical reactor and an always sufficient production of water, oxygen, hydrogen, and electrical energy is ensured.

According to a further exemplary embodiment of the present invention, the carbon monoxide produced in the FP assembly can be supplied to an anode of the SOSE assembly.

A lowering of the SOSE cell voltage may hereby be achieved.

According to a further exemplary embodiment of the present invention, the hydrogen produced in the SOSE assembly can be supplied to an anode of the SOFC assembly, in particular, for increasing the conversion in the SOFC assembly or for regeneration of the SOFC anode, to a PEM-fuel cell, or a downstream combustion process.

In addition to a method-technical optimizing of the processes running in the reactor, in particular, a decomposition of the degradation of the SOFC anode formed by sulfurous fractions in reformate may be ensured. Advantageously, the hydrogen is produced within the electrochemical reactor, so that a system-internal desulphurization of the SOFC anode can be performed and therewith, a desulphurization unit with the fuel preparation of the fuel in the FP assembly is eliminated.

According to a further advantageous and exemplary embodiment of the present invention, the water produced in the SOFC assembly can be supplied to a cathode of the SOSE assembly, the FP assembly, or the application in the on-board operation.

In this manner, supplying additional water from external water storage sources to the system may be avoided advantageously.

According to a further embodiment of the present invention, individual cells or interconnections of cells are controllable or regulatable by the control unit in dependence on on-board requirements or the processes running in the reactor, in particular, also the regeneration processes.

It may be is ensured that minimal total requirements of raw materials or energy result from a corresponding performance-related regulation of the reactor, so that, for example, individual subunits can be switched off, in order for a successive regeneration or purification process to be subdued. The purification process can operate, for example, as a desulphurization of an SOFC anode.

According to a further exemplary embodiment of the present invention, individual cells or interconnections of cells can be dried after switching off by means of post-heating of a thermal storage capacity or the supplying of an inert gas.

For this drying, no supply of system-external energy may be necessary, since the thermal storage capacity, for example, is a component of the electrochemical reactor.

According to a further advantageous embodiment of the present invention, an aircraft is provided with an electrochemical reactor for production of energy, hydrogen, oxygen, and clear water from grey water, a hydrocarbon-containing fuel and air, including a fuel cell assembly, an electrolytic cell assembly, and a fuel processor assembly, whereby the process heat produced by the fuel cell assembly can be used in the electrolytic cell assembly for an electrolytic process and in the fuel processor assembly for a reforming process, and whereby the hydrogen produced in the electrolytic cell assembly can be used for regeneration of an anode of the fuel cell assembly.

In this regard, an aircraft may be provided, which demonstrates an improved provisioning with energy and raw materials, so that large storage volumes and weight for storing required raw materials or also for production of energy can be reduced or completely avoided. In addition, the aircraft has an electrochemical reactor, which is designed, such that the hydrogen produced in the SOS assembly can be used for a cyclical regeneration of individual SOFC anodes, so that, advantageously, a separate desulphurization assembly is eliminated and any number of thermal load changes can be driven without degradation loss.

According to a further exemplary embodiment of the present invention, a method for operating an electrochemical reactor with a fuel cell assembly, an electrolytic cell assembly, and a fuel cell processor assembly in an aircraft or a spacecraft is provided, in which the energy, hydrogen, oxygen, and clear water from grey water, a hydrocarbon-containing fuel and air is produced in an electrochemical reactor.

This exemplary embodiment provides a method, through which it is believed that an improved supplying of aircraft or spacecraft with energy, hydrogen, oxygen, and clear water is ensured, so that large storage volumes and weight for storing necessary raw materials or also for production of energy can be reduced or completely avoided.

According to a further exemplary embodiment of the present invention, the process heat produced by the fuel cell assembly is used in the electrolytic cell assembly for an electrolytic process and in the fuel processor assembly for a reforming process, whereby the hydrogen produced in the electrolytic cell assembly is use for regeneration of an anode of the fuel cell assembly.

Therefore, with the method of the present invention the hydrogen produced in the SOSE assembly can be used for a cyclical regeneration of individual SOFC anodes, so that a separate desulphurization assembly may be eliminated and any number of thermal load changes can be driven without degradation loss.

Further advantageous embodiments of the present invention are provided in the dependent claims.

### BRIEF DESCRIPTION OF THE DRAWINGS

Next, preferred embodiments of the present invention will be described with reference to the accompanying figures.

FIG. 1 shows a schematic, method-technical representation of an electrochemical reactor according to an exemplary embodiment of the present invention;

FIG. 2 shows a schematic representation of the electrochemical processes running in the electrochemical reactor and the corresponding supply circuits;

FIG. 3 shows schematically an exemplary assembly of multiple SOFC cells and SOSE cells within an electrochemical reactor.

### DETAILED DESCRIPTION

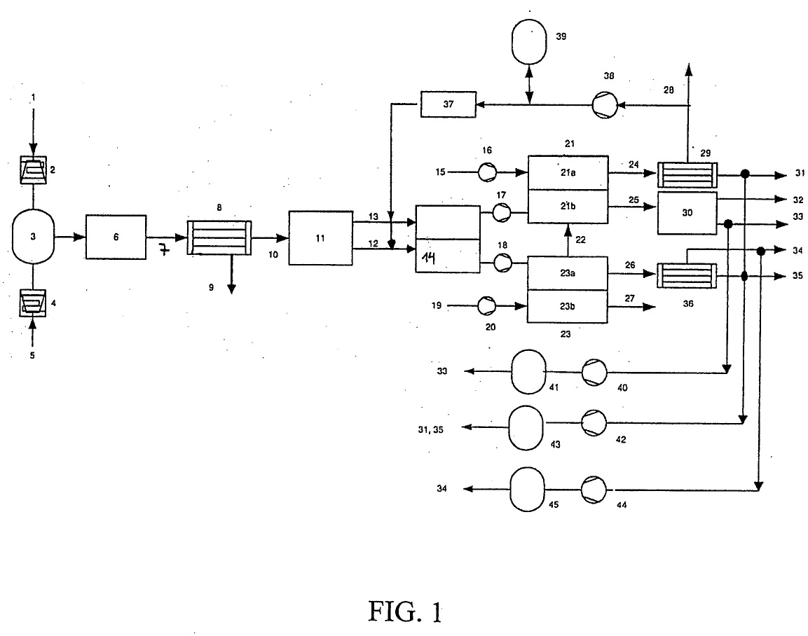

FIG. 1 shows a schematic, method-technical representation of an electrochemical reactor according to an exemplary embodiment of the present invention. The electrochemical reactor comprises a fuel cell assembly (SOFC assembly) 23, an electrolytic cell assembly (SOSE assembly) 21, and a fuel processor assembly (FP assembly) 6.

In particular, the electrochemical reactor shown in FIG. 1 operates as a modular, integrated electrochemical reactor for production of electrical energy, hydrogen, oxygen, and water for the use in aircraft. Fuel cell assemblies, such as, for example, a solid oxide fuel cell assembly, also can be used for water production in addition to current production, according to the present invention. Electrolytic cell assemblies, such as, for example, a solid oxide electrolytic cell, can produce hydrogen and oxygen in the embodiment as a “solid oxide steam electrolyzer.”

SOFC and SOSE are known technical systems. With a suitable combination of these two systems, it is also possible to use the fuel produced from the fuel processor in a process-technical manner, such that with the production of electrical energy, hydrogen, oxygen, and water, the requirement can be performed according to a continuous load range, and therewith, the thermal cycling of both high temperature systems SOSE and SOFC is stabilized.

Obtaining of water and oxygen, in particular, is important for air and space travel, since here, autonomous systems for on-board supply are required, in order to avoid large storage volumes and weight.

The fuel processor 6 of the electrochemical reactor of the present invention is supplied via a mixing unit 3 with a hydrocarbon-containing fuel, such as, for example, kerosene 1, and water, with which it can operate as a purified grey water 5. Before fuel 1 and grey water 5 are supplied to the fuel processor 6, a vaporization of the fuel 1 in a vaporizer 2 and a vaporization of the purified grey water 5 in a water vaporizer 4 takes place. The energy required for the vaporization of fuel 1 or grey water 5 can originate, for example, from the cathode exhaust from the cathode 21a of the electrolytic cell assembly or from the anode exhaust of the anode 23a of the fuel cell assembly.

In the mixing unit 3, fuel vapor and grey water vapor are mixed and supplied to the fuel processor 6. In the FP 6, the a reformate gas 7 is produced for the subsequent processes from the hydrocarbon-containing fuel 1 and the water 5, which contains the primary components hydrogen, carbon monoxide, and water vapor.

In the condenser 8, a separation of the water of the hydrogen-water vapor-carbon monoxide gas mixture 7 takes place and the separated water 9 is intermediately stored in a container 43 or buffered and the remaining gas, hydrogen, and carbon monoxide are supplied 10 to a downstream molecular sieve 11 and there separated.

The separated water 9 can be supplied, for example, via a suitable pump (not shown in FIG. 1) to the intermediate storage unit 43 or, however, also via the pump 42, which also is used for water emanating from the condensers 29 and 36 (the corresponding lines are not shown in FIG. 1).

The (if necessary, sulfurous) hydrogen 12 and the carbon monoxide 13 are heated subsequently in a heating apparatus 14 in separated chambers and thereafter condensed via a hydrogen condenser 18, or a respective carbon monoxide condenser 17 and transported on.

The condensed and eventually sulfurous hydrogen is supplied to an anode 23a of the SOFC assembly 22. In addition to the hydrogen from the FP 6, as will be described in greater detail subsequently, the anode site 23a of the SOFC 23 is supplied with hydrogen from the SOSE 21. The distribution and production of the hydrogen flows for the SOFC 23 is regulated by the requirements of hydrogen, oxygen, water, and electrical energy.

The oxygen for the SOFC cathode 23b is taken from the atmospheric air or the cabin air 19 and compressed via a compressor 20 to the working pressure of the SOFC 23.

The hydrogen-water vapor-gas mixture in the anode exhaust flow of the SOFC 23 is separated in a downstream condenser 36 and the separated hydrogen is intermediately stored or buffered in a container 45.

The separated hydrogen 34 contains typically a known sulfur portion and is compressed for storage in a buffer for sulfurous hydrogen 45 by a hydrogen compressor 44. Via a line 34, the hydrogen can be supplied, for example, to a downstream combustion process.

The water separated in the condenser 36 is supplied via the water pump 42 to the water intermediate storage unit or water buffer 43. Alternatively, the water can be released via the water outlet 35; likewise, the separated hydrogen can be released via the hydrogen outlet 34.

The air in the cathode exhaust flow of the SOFC 22 is released via the air outlet 27.

The SOSE 21 is supplied on the cathode side 21 a with water vapor 15, which was compressed accordingly in the water vapor compressor 16. On the anode side 21b, the SOSE 21 is supplied with carbon monoxide from the FP 6, which is correspondingly compressed in the carbon monoxide compressor 17. The water vapor for the cathode-side supply of the SOSE 21 emanates, according to an exemplary embodiment of the present invention, from the water container 43 and, therewith, a reactor-internal process. For this purpose, for example, an outlet 31 is provided, via which the water from the container 43 is supplied to the water compressor 16 in the form of water vapor. Alternatively, the water from the container 43 can be supplied also via the outlet 35 to the vaporizer 4, after which it is then forwarded to the water compressor 16.

In the SOSE 21, from the water vapor, hydrogen and oxygen are produced. According to the present invention, the oxidation of the carbon monoxide with the oxygen produced on the anode side to carbon dioxide causes a reduction of the cell voltage of the SOSE 21.

The SOSE can obtain additional water vapor from the vaporizer 4 for the FP 6. The electrolytic flow relates to the SOSE 21 from the SOFC 23. The distribution and production of the water vapor flows for the SOSE 21 is regulated by the requirements of hydrogen, oxygen, water, and electrical energy.

The oxygen produced on the anode 21b of the SOSE 21 and the carbon dioxide are supplied via the line 25 to the molecular sieve 30 and there separated. The separated oxygen is compressed via the oxygen compressor 40 and conducted to a container 41 for intermediate storage or buffering. Alternatively, the separated oxygen can be released via an oxygen outlet 33.

The carbon dioxide separated in the molecular sieve 30 can be released via a carbon dioxide outlet 32.

The cathode-side released hydrogen/water vapor mixture is conducted via the line 24 to the condenser 29. The pure hydrogen separated in the condenser 29 is intermediately stored in a container 29 or buffered, after it was compressed accordingly by the hydrogen compressor 38. Alternatively, the hydrogen released from the condenser 29 can be released via the hydrogen outlet 28. The pure hydrogen intermediately stored in the hydrogen intermediate storage 39 can be heated subsequently, likewise, like the pure hydrogen originating directly from the condenser 29, by a heating apparatus 37 to a corresponding reaction-friendly temperature, and thereafter, for example, for increasing the conversion, be conducted to the anode side 23a of the SOFC 23. This takes place, for example, via line 12, heating apparatus 14, and hydrogen compressor 18.

Alternatively, the hydrogen produced internally in the reactor can be conducted to a downstream PEM-fuel cell (polymer-electrolytic-fuel cell) or a downstream combustion process.

According to this, the produced oxygen and the produced water are intermediately stored or buffered in containers 41, 43 and are either used again in the entire process or supplied to the on-board supply for water or oxygen. The intermediately stored or buffered hydrogen (pure) can either be supplied gain to the SOFC 23 or can be used in another fuel cell process or combustion process.

By means of a spatial integration of SOFC 23, SOSE 21, and FP 6 in a casing or housing, the reaction heat released in the SOFC 23 is used as additional process heat in the SOSE- and FP-processes.

It should be noted that the water for the production of water vapor in the vaporizer 4 for the FP 6 and the SOSE 21 is purified grey water 5 from the on-board operation and/or water from the intermediate storage or buffer storage 43.

Advantageously, the heat output for the water vaporizer 4 and the kerosene vaporizer 2 is taken from the cathode exhaust of the SOSE 21 and the anode exhaust of the SOFC 23, respectively, from the condensers 29, 36.

In addition, according to an exemplary embodiment of the present invention, the fuel cells 23 and electrolytic cells 21 are embodied in multi-cellular form as a fuel cell stack and electrolytic cell stack.

By means of the integration of the three reactors FP 6, SOSE 21, and SOFC 23 in a thermally insulated casing or housing, the process heat produced by the SOFC 23 is used in the SOSE 21 and in the FP 6 for the respective electrolysis or reforming process. In this manner, with operation of the entire process, the energy loss, which, for example, exists by additional heat transfer units, may effectively be minimized.

The reforming process, which runs in the FP, operates, for example, as the conversion from a hydrocarbon-containing fuel (such as, for example, kerosene) into a reformate gas, which contains hydrogen, carbon monoxide, and water vapor as primary components.

These days, kerosene supplied for civil air travel contains, for example, approximately 300 ppm sulfur and it is known that the anode of the SOFC 23 can be contaminated by sulfur. In order to break down degradations formed by the sulfurous fractions in reformate on the SOFC anode 23a, according to the present invention, the hydrogen produced in the SOSE or the intermediately stored or buffered hydrogen is supplied for regeneration to the SOFC anode 23a. Since the hydrogen requirement for the regeneration of the SOFC anode 23a contaminated by sulfur depends on the remaining requirements of oxygen, water, electrical energy, and operating time, by means of the intermediate storage or buffering, always a sufficient amount of hydrogen is maintained. In this type of regeneration method, a desulphurization with the fuel preparation of the fuel in FP 6 is eliminated.

The method-technical devices required for the entire process are designed according to generally known technical principles.

According to a another embodiment of the present invention, multiple fuel cell stacks or electrolytic cell stacks or fuel processors are integrated in parallel or serial connection or parallel-serial connection. In addition, according to an exemplary embodiment of the present invention, it is provided that subsystems comprise multiple fuel cell stacks and electrolytic cell stacks, and fuel cell process assemblies can be interconnected in parallel- or serial connection or parallel-serial connection to a total system or subsystem. An individual subsystem can comprise an FP-SOSE-SOFC system or an FP-SOFC system or a SOSE-SOFC system or an FP system or SOFC system or SOSE system.

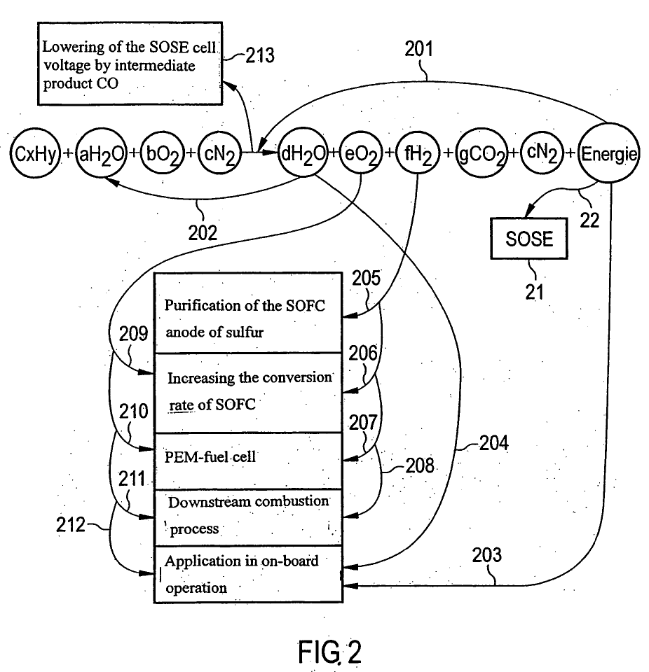

FIG. 2 shows a schematic representation of the electrochemical processes running in the electrochemical reactor and the corresponding supply circuits. In the electrochemical reactor, a hydrocarbon-containing fuel CxHy, a part water, b part oxygen, and c part nitrogen are converted to d part clear water, e part oxygen, f part pure hydrogen, g part carbon dioxide, h part nitrogen, and energy. The energy acts on the one hand as thermal energy, which can be supplied for vaporizing of the hydrocarbon-containing fuel or for vaporizing of the process-supplied water or, however, also for an electrolytic process into the SOSE assembly or a reforming process in the FP assembly.

On the other hand, the produced energy acts also in the SOFC assembly as produced electrical energy, which can be used on the one hand for on-board operation 203 or, however, also can be supplied to the SOSE 21 via a current supply 22 for the electrolytic cell process (see FIG. 1).

The water produced in the process be supplied on the one hand to the process again 202, according to the present invention, or also can be used for the application in on-board operation 204.

The oxygen produced in the process can be used for the application in on-board operation 212 or is supplied to a downstream combustion process 211 or a PEM fuel cell 210. In addition, the produced oxygen serves to increase the conversion of the SOFC 209.

The produced (pure) hydrogen is used, for example, for purifying the SOFC anode from sulfur 205. In this type of regeneration method, desulphurization unit advantageously can be eliminated with the fuel preparation of the fuel for the FP. In addition, the produced hydrogen can be used for increasing the conversion of the SOFC 206 or, however, also supplied to a downstream combustion process 208 or a PEM fuel cell 207.

The carbon monoxide produced as an intermediate produce in FP, after it is separated by the molecular sieve 11 (see FIG. 1), is useable for lowering the SOSE cell voltage 213.

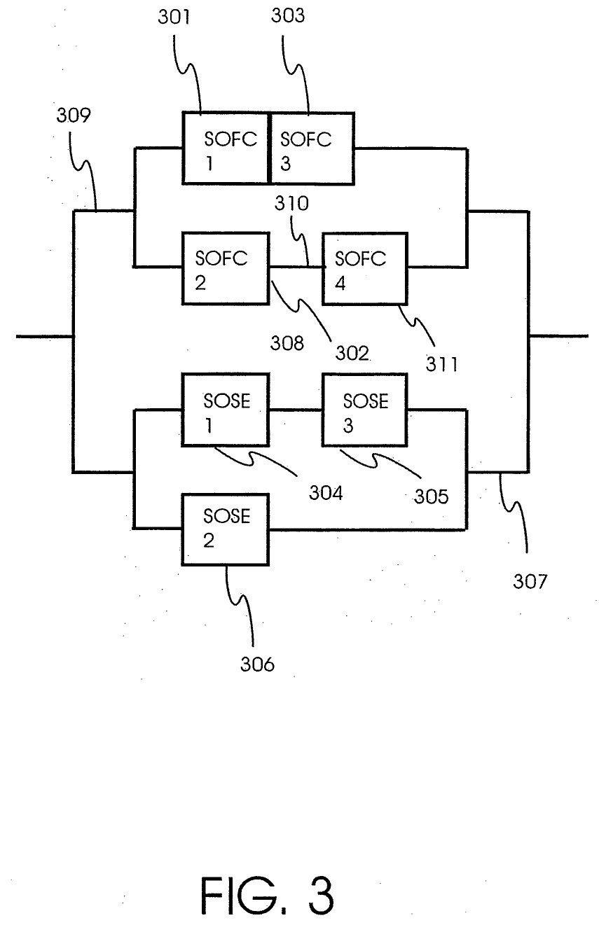

FIG. 3 shows schematically an exemplary assembly of multiple SOFC cells and SOSE cells within an electrochemical reactor according to the present invention. The assembly includes hereby a first SOFC cell 301, a second SOFC cell 302, a third SOFC cell 303, and a fourth SOFC cell 311. First and third SOFC cells 301, 303 are hereby formed as a fuel cell stack. Second and fourth SOFC cells 302, 311 are serially connected to one another via a line system 310 and additionally via line systems 309 and 307, are connected in parallel with the fuel cell stack 301, 303.

In addition, the assembly includes a first SOSE cell 304, a second SOSE cell 306, and a third SOSE cell 305. First and third SOSE cells 304, 305 are hereby serially connected with one another via line system 308 and are connected in parallel with the second SOSE cell 306 via line systems 309, 307. In addition, the SOSE cells 304, 305, 306 are connected with the SOFC cells 301, 302, 303, 304 via the line systems 309, 307.

The invention is not limited in its implementation to the exemplary embodiments shown in the figures. In addition, a plurality of variations are contemplated, which make use of the shown solution and inventive principle also with basically different embodiments.

In addition, it should be noted that “including” does not exclude other elements or steps and “a” or “one” does not exclude a plurality. In addition, it should be noted that features or steps, which have been described with reference to one of the above-described exemplary embodiments, also can be used in combination with other features or steps of another above-described embodiment. Reference numerals in the claims are not to be viewed as limitations.

1. Electrochemical reactor in an aircraft or spacecraft, comprising:
a fuel cell assembly;
an electrolytic cell assembly;
a fuel processor assembly;
wherein the electrochemical reactor is adapted for producing energy, hydrogen, oxygen, and clear water from grey water, a hydrocarbon-containing fuel, and air.

2. The electrochemical reactor of claim 1,
wherein the process heat produced by the fuel cell assembly is used in the electrolytic cell assembly for an electrolytic process and in the fuel processor assembly for a reforming process; and
wherein the hydrogen produced in the electrolytic cell assembly is used for regenerating an anode of the fuel cell assembly.

3. The electrochemical reactor of claim 1, further including:
a control unit for controlling the reactor, such that the energy produced by the fuel cell supplies at least a portion of the energy required by one or more of the electrolytic cell assembly, the fuel processor assembly or an on-board operation.
wherein the load range, in which the process are driven, is continuous; and
wherein the processes yield altogether the oxygen required for the on-board operation, the clear water, and at least a part of the required energy.

4. The electrochemical reactor of claim 1, wherein the fuel cell assembly, the electrolytic cell assembly, and the fuel processor assembly are disposed in a thermally insulated casing.

5. The electrochemical reactor of claim 1, wherein the electrolytic assembly or the fuel cell assembly include oxygen ion-conducting solid electrolytes.

6. The electrochemical reactor of claim 1,
wherein the electrolytic cell assembly includes a first or a second electrolytic cell;
wherein the fuel cell assembly includes a first fuel cell or a second fuel cell;
wherein the fuel processor assembly includes a first fuel processor cell or a second fuel processor cell; and
wherein respective two cells of the first electrolytic cell, the second electrolytic cell, the first fuel cell, the second fuel cell, the first fuel processor cell and the second fuel processor cell are connected in one of parallel and in series to one another.

7. The electrochemical reactor of claim 1,
wherein the first electrolytic cell is formed with at least one third electrolytic cell as a multi-cellular electrolytic cell stack or the first fuel cell is formed with at least one third fuel cell as a multi-cellular fuel cell stack.

8. The electrochemical reactor of claim 1,
wherein the oxygen produced in the electrolytic cell assembly is supplied to a cathode of the fuel cell assembly, an on-board operation, a PEM-fuel cell or a downstream combustion process.

9. The electrochemical reactor of claim 1,
wherein the oxygen produced in the electrolytic cell assembly is supplied to an anode of the electrolytic cell assembly.

10. The electrochemical reactor of claim 1,
wherein the hydrogen produced in the electrolytic assembly is supplied to an anode of the fuel cell assembly, for increasing the conversion in the fuel cell assembly or for regeneration of an anode, a PEM fuel cell, or a downstream combustion process.

11. The electrochemical reactor of claim 1,
wherein water produced in the fuel cell assembly is supplied to at least one of a cathode of the electrolytic cell assembly, the fuel processor assembly, or an on-board operation.

12. The electrochemical reactor of claim 1, further comprising a
control unit for controlling individual cells of the fuel cell in dependence on at least one of an on-board requirement, at least one of the processes running in the reactor, or the regeneration processes.

13. The electrochemical reactor of claim 1,
wherein at least one cell of the fuel cell assembly, after shutting down by a post-heating of a thermal storage capacity or the supply of an inert gas, can be dried.

14. Aircraft with an electrochemical reactor according to claim 1.

15. Method for operating an electrochemical reactor with a fuel cell assembly, an electrolytic cell assembly, and a fuel processor assembly in an aircraft or spacecraft, including the step:
producing at least one of energy, hydrogen, oxygen, and clear water from grey water, a hydrocarbon-containing fuel and air in an electrochemical reactor.

16. The method of claim 15,
wherein process heat produced from the fuel cell assembly is used in the electrolytic cell assembly for an electrolytic process and/or in the fuel process assembly for a reforming process; and
wherein the hydrogen produced in the electrolytic cell assembly is used for regeneration of an anode of the fuel cell assembly.

17. The method of claim 15,
wherein a control unit controls the processes running in the reactor, such that the energy produced by the fuel cell assembly corresponds to the energy required by the electrolytic cell assembly or the fuel cell process assembly or by on-board operation;
wherein the processes are driven, is continuous; and
wherein the processes yield altogether the electrical energy, oxygen, and the clear water required for an on-board operation.

18. The method of claim 15,
wherein oxygen produced in the electrolytic assembly is supplied to a cathode of the fuel cell, is used in an on-board operation, is supplied to a PEM fuel cell or is supplied to a downstream combustion process.

19. The method of claim 15,
wherein carbon monoxide produced in the fuel processor assembly is supplied to an anode of the electrolytic cell assembly.

20. The method of claim 15,
wherein hydrogen produced in the electrolytic cell assembly is supplied to an anode of the fuel cell assembly, for increasing the conversion in the fuel cell assembly or for regeneration of the anode of the fuel cell assembly, to a PEM fuel cell or a downstream combustion process.

21. The method of claim 15,
wherein water produced in the fuel cell assembly is supplied to at least one of the cathode of the electrolytic cell assembly, the fuel processor assembly or for use in an on-board operation.

22. The method of claim 15, further comprising a control unit,
wherein the control unit controls individual cells or interconnections of cells in dependence on at least of on-board requirements, the processes running in the reactor, and the regeneration processes.

23. The method of claim 15,
wherein individual cells or interconnections of cells, after shutting down by post-heating of a thermal storage capacity or supplying of an inert gas, are dried.
